(19) United States
(12) Patent Application Publication
(10) Pub. No.: US 2024/0149945 A1
(43) Pub. Date: May 9, 2024

(54) FRAME STRUCTURE

(71) Applicant: ISUZU MOTORS LIMITED, Tokyo (JP)

(72) Inventor: Kenichi HORIGUCHI, Fujisawa-shi, Kanagawa, (JP)

(21) Appl. No.: 18/550,696

(22) PCT Filed: Mar. 17, 2022
(86) PCT No.: PCT/JP2022/012378

§ 371 Date: Sep. 15, 2023

(30) Foreign Application Priority Data
Mar. 19, 2021 (JP) 2021-046306

(51) Int. Cl. B62D 21/03

(52) U.S. Cl. CPC B62D 21/03

(57) ABSTRACT

A frame structure includes: a plurality of side members which extend in the longitudinal direction of a vehicle and on which a cargo bed of the vehicle is to be mounted; a plurality of support members, each of which is provided outward from the plurality of side members in the width direction of the vehicle and extends in the longitudinal direction of the vehicle; and at least one or more cross members that are provided between the plurality of support members and extend through the plurality of side members in the width direction of the vehicle.

### TECHNICAL FIELD

The present disclosure relates to a frame structure in a vehicle.

### BACKGROUND OF THE INVENTION

A vehicle is provided with a frame structure. Patent Document 1 discloses a front vehicle provided with a pair of front frames which is disposed in the width direction of the vehicle, extends in the longitudinal direction of the vehicle, and to which a front cargo bed to be loaded with goods is mounted and fixed.

### PRIOR ART

### Patent Document

Japanese Unexamined Patent Application Publication No. 2016-64699

### BRIEF DESCRIPTION OF THE INVENTION

### Problem to be Solved by the Invention

In a vehicle, a cargo bed may be mounted on a plurality of side members extending in the longitudinal direction of the vehicle. In this case, in order to ensure longitudinal bending strength and rigidity by the plurality of side members, the side members require a sufficient length in the height direction of the vehicle, so that providing the cargo bed at a lower position has been difficult.

Accordingly, the present disclosure has been made in view of these points, and its object is to provide a frame structure that makes it easier to provide a cargo bed at a lower position.

### Means for Solving the Problem

An aspect of the present disclosure provides a frame structure including: a plurality of side members which extend in a longitudinal direction of a vehicle and on which a cargo bed of the vehicle is to be mounted; a plurality of support members, each of which is provided outward from the plurality of side members in a width direction of the vehicle and extends in the longitudinal direction; and at least one or more cross members that are provided between the plurality of support members and extend through the plurality of side members in the width direction.

Further, the frame structure may be provided with, as the at least one or more cross members: a first cross member provided at front ends of the plurality of support members in the longitudinal direction; a second cross member provided at centers of the plurality of support members in the longitudinal direction; and a third cross member provided at rear ends of the plurality of support members in the longitudinal direction.

Further, a length of the support member in a height direction of the vehicle may be smaller than a length of the side member in the height direction.

Further, the first cross member may extend through the plurality of side members in the width direction, and the second cross member and the third cross member need not extend through the plurality of side members in the width direction.

Further, the frame structure may be provided with: a left side member provided on a left side in the width direction, and a right side member provided on a right side in the width direction, as the plurality of side members; a left support member provided on a left side of the left side member in the width direction, and a right support member provided on a right side of the right side member in the width direction, as the plurality of support members; a second left cross member provided between the left support member and the left side member, and a second right cross member provided between the right support member and the right side member, as the second cross members; and a third left cross member provided between the left support member and the left side member, and a third right cross member provided between the right support member and the right side member, as the third cross members.

### Effect of the Invention

According to the present disclosure, an effect of more easily providing a cargo bed at a lower position in a frame structure is achieved.

### BRIEF DESCRIPTION OF THE DRAWINGS

FIG. 1 shows a state where a frame structure according to the present embodiment is provided in a vehicle.

FIG. 2 shows a configuration of the frame structure according to the present embodiment.

FIG. 3 shows a configuration of the frame structure as a modified example.

### DESCRIPTION OF EMBODIMENTS

### [Peripheral Configuration of the Frame Structure S]

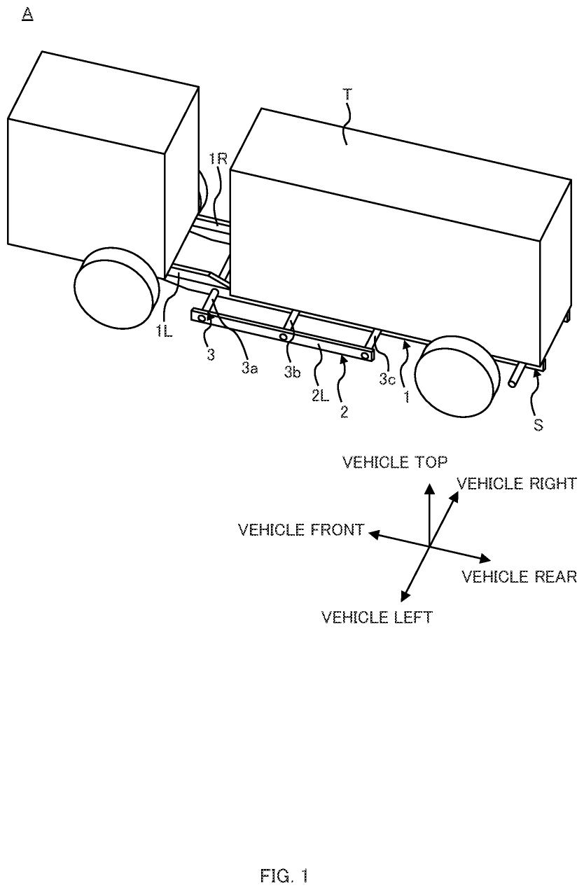

FIG. 1 shows a state where a frame structure S according to the present embodiment is provided in a vehicle A.

The frame structure S is provided in the vehicle A. The vehicle A is a truck, for example. The vehicle A has a cargo bed T. The cargo bed T accommodates objects from the outside. The cargo bed T has a box shape, for example. The cargo bed T is mounted on the frame structure S. The frame structure S supports the cargo bed T. The frame structure S includes a ladder frame, for example. The frame structure S extends in the longitudinal direction of the vehicle A.

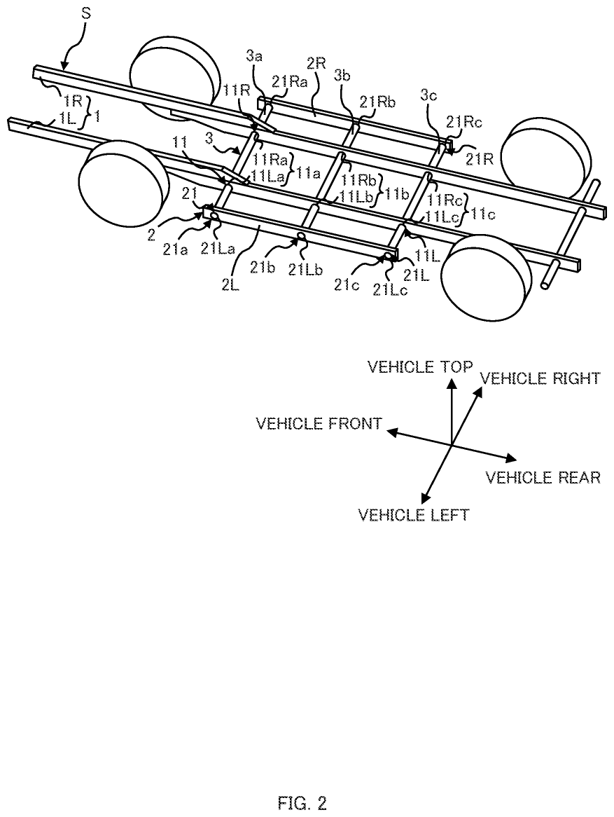

FIG. 2 shows a configuration of the frame structure S according to the present embodiment.

The frame structure S includes a plurality of side members 1, a plurality of support members 2, and at least one or more cross members 3.

The plurality of side members 1 extend in the longitudinal direction of the vehicle A. The cargo bed T of the vehicle A is to be mounted on the plurality of side members 1. Each side member 1 has a plurality of holes 11. Each hole 11 penetrates through the side member 1 in the width direction of the vehicle A. The cross member 3 to be described later is inserted in the hole 11. The plurality of holes 11 are arranged side by side on the side member 1 in the longitudinal direction of the vehicle A.

The side member 1 has, as the plurality of holes 11, a hole 11a, a hole 11b, and a hole 11c in order from the front to the rear in the longitudinal direction of the vehicle A. A first cross member 3a to be described later is inserted in the hole 11a. A second cross member 3b to be described later is inserted in the hole 11b. A third cross member 3c to be described later is inserted in the hole 11c.

The frame structure S is provided with a left side member 1L and a right side member 1R as the plurality of side members 1. The left side member 1L extends in the longitudinal direction of the vehicle A. The left side member 1L is provided on the left side in the width direction of the vehicle A. The left side member 1L has a plurality of holes 11L. The holes 11L penetrate through the left side member 1L in the width direction of the vehicle A. The cross member 3 to be described later is inserted in the holes 11L. The plurality of holes 11L are arranged side by side on the left side member 1L in the longitudinal direction of the vehicle A.

The left side member 1L has, as the plurality of holes 11L, a hole 11La, a hole 11Lb, and a hole 11Lc in order from the front to the rear in the longitudinal direction of the vehicle A. The first cross member 3a to be described later is inserted in the hole 11La. The second cross member 3b to be described later is inserted in the hole 11Lb. The third cross member 3c to be described later is inserted in the hole 11Lc.

The right side member 1R extends in the longitudinal direction of the vehicle A. The right side member 1R is provided on the right side in the width direction of the vehicle A. The right side member 1R has a plurality of holes 11R. The holes 11R penetrate through the right side member 1R in the width direction of the vehicle A. The cross member 3 to be described later is inserted in the holes 11R. The plurality of holes 11R are arranged side by side on the right side member 1R in the longitudinal direction of the vehicle A.

The right side member 1R has, as the plurality of holes 11R, a hole 11Ra, a hole 11Rb, and a hole 11Rc in order from the front to the rear in the longitudinal direction of the vehicle A. The first cross member 3a to be described later is inserted in the hole 11Ra. The second cross member 3b to be described later is inserted in the hole 11Rb. The third cross member 3c to be described later is inserted in the hole 11Rc.

Each of the plurality of support members 2 is provided outward from the plurality of side members 1 in the width direction of the vehicle A. The plurality of support members 2 extend in the longitudinal direction of the vehicle A. The support members 2 have a plurality of holes 21. Each hole 21 penetrates through the support member 2 in the width direction of the vehicle A. The cross member 3 to be described later is inserted in each hole 21. The plurality of holes 21 are arranged side by side on the support member 2 in the longitudinal direction of the vehicle A.

The support member 2 has, as the plurality of holes 21, a hole 21a, a hole 21b, and a hole 21c in order from the front to the rear in the longitudinal direction of the vehicle A. The hole 21a is provided at a front end of the support member 2 in the longitudinal direction of the vehicle A. The first cross member 3a to be described later is inserted in the hole 21a. The hole 21b is provided at the center of the support member 2 in the longitudinal direction of the vehicle A. The second cross member 3b to be described later is inserted in the hole 21b. The hole 21c is provided at a rear end of the support member 2 in the longitudinal direction of the vehicle A. The third cross member 3c to be described later is inserted in the hole 21c.

The frame structure S is provided with a left support member 2L and a right support member 2R as the plurality of support members 2. The left support member 2L extends in the longitudinal direction of the vehicle A. The left support member 2L is provided on the left side of the left side member 1L in the width direction of the vehicle A. The left support member 2L is provided within the wheelbase of the vehicle A. In the longitudinal direction of the vehicle A, the left support member 2L is provided between a front wheel shaft and a rear wheel shaft on the left side in the width direction of the vehicle A. The left support member 2L has a plurality of holes 21L. The hole 21L penetrates through the left support member 2L in the width direction of the vehicle A. The cross member 3 to be described later is inserted in the hole 21L. The plurality of holes 21L are arranged side by side on the left support member 2L in the longitudinal direction of the vehicle A.

The left support member 2L has, as the plurality of holes 21L, a hole 21La, a hole 21Lb, and a hole 21Lc in order from the front to the rear in the longitudinal direction of the vehicle A. The hole 21La is provided at a front end of the left support member 2L in the longitudinal direction of the vehicle A. The first cross member 3a to be described later is inserted in the hole 21La. The hole 21Lb is provided at the center of the left support member 2L in the longitudinal direction of the vehicle A. The second cross member 3b to be described later is inserted in the hole 21Lb. The hole 21Lc is provided at a rear end of the left support member 2L in the longitudinal direction of the vehicle A. The third cross member 3c to be described later is inserted in the hole 21Lc.

The right support member 2R extends in the longitudinal direction of the vehicle A. The right support member 2R is provided on the right side of the right side member 1R in the width direction of the vehicle A. The right support member 2R is provided within the wheelbase of the vehicle A. In the longitudinal direction of the vehicle A, the right support member 2R is provided between a front wheel shaft and a right rear wheel shaft on the right side in the width direction of the vehicle A. The right support member 2R has a plurality of holes 21R. The holes 21R penetrate through the right support member 2R in the width direction of the vehicle A. The cross member 3 to be described later is inserted in the holes 21R. The plurality of holes 21R are arranged side by side on the right support member 2R in the longitudinal direction of the vehicle A.

The right support member 2R has, as the plurality of holes 21R, a hole 21Ra, a hole 21Rb, and a hole 21Rc in order from the front to the rear in the longitudinal direction of the vehicle A. The hole 21Ra is provided at a front end of the right support member 2R in the longitudinal direction of the vehicle A. The first cross member 3a to be described later is inserted in the hole 21Ra. The hole 21Rb is provided at the center of the right support member 2R in the longitudinal direction of the vehicle A. The second cross member 3b to be described later is inserted in the hole 21Rb. The hole 21Rc is provided at a rear end of the right support member 2R in the longitudinal direction of the vehicle A. The third cross member 3c to be described later is inserted in the hole 21Rc.

The at least one or more cross members 3 are provided between the plurality of support members 2. The at least one or more cross members 3 are provided between the left support member 2L and the right support member 2R in the width direction of the vehicle A. A left end of the at least one or more cross members 3 is fixed to the left support member 2L in a state of being inserted in the hole 21L of the left support member 2L. A right end of the at least one or more cross members 3 is fixed to the right support member 2R in a state of being inserted in the hole 21R of the right support member 2R.

The at least one or more cross members 3 extend through the plurality of side members 1 in the width direction of the vehicle A. The at least one or more cross members 3 are inserted in the hole 11 of the side member 1. The at least one or more cross members 3 are inserted in the hole 11L of the left side member 1L and the hole 11R of the right side member 1R.

As described above, the frame structure S includes the plurality of support members 2 and the at least one or more cross members 3. The at least one or more cross members 3 are provided between the plurality of support members 2, and extend through the plurality of side members 1 in the width direction of the vehicle A. Therefore, in the frame structure S, the load applied to the plurality of side members 1 from the cargo bed T can be supported by the plurality of support members 2 as well, through the at least one or more cross members 3. As a result, the frame structure S can reduce the load supported by the plurality of side members 1, making it possible to reduce lengths of the plurality of side members 1 in the height direction of the vehicle A. Therefore, the frame structure S makes it easier to provide the cargo bed T at a lower position.

The frame structure S is provided with the first cross member 3a, the second cross member 3b, and the third cross member 3c as the at least one or more cross members 3. The first cross member 3a is provided at front ends of the plurality of support members 2 in the longitudinal direction of the vehicle A. The first cross member 3a is inserted in the hole 11La of the left side member 1L and the hole 11Ra of the right side member 1R. A left end of the first cross member 3a is fixed to the left support member 2L in a state of being inserted in the hole 21La of the left support member 2L. A right end of the first cross member 3a is fixed to the right support member 2R in a state of being inserted in the hole 21Ra of the right support member 2R.

The second cross member 3b is provided at the centers of the plurality of support members 2 in the longitudinal direction of the vehicle A. The second cross member 3b is inserted in the hole 11Lb of the left side member 1L and the hole 11Rb of the right side member 1R. A left end of the second cross member 3b is fixed to the left support member 2L in a state of being inserted in the hole 21Lb of the left support member 2L. A right end of the second cross member 3b is fixed to the right support member 2R in a state of being inserted in the hole 21Rb of the right support member 2R.

The third cross member 3c is provided at rear ends of the plurality of support members 2 in the longitudinal direction of the vehicle A. The third cross member 3c is inserted in the hole 11Lc of the left side member 1L and the hole 11Rc of the right side member 1R. A left end of the third cross member 3c is fixed to the left support member 2L in a state of being inserted into the hole 21Lc of the left support member 2L. A right end of the third cross member 3c is fixed to the right support member 2R in a state of being inserted in the hole 21Rc of the right support member 2R.

As described above, the frame structure S includes the first cross member 3a, the second cross member 3b, and the third cross member 3c as the at least one or more cross members 3. Therefore, in the frame structure S, it is possible to easily disperse the load applied to the plurality of side members 1 from the cargo bed T, and easily transmit the load to the plurality of support members 2 through the plurality of cross members 3 in the longitudinal direction of the vehicle A. Further, in the frame structure S, the support member 2 can be easily deformed by following deformation of the side member 1, thereby reducing the load supported by the side member 1.

The length of the support member 2 in the height direction of the vehicle A is smaller than the length of the side member 1 in the height direction of the vehicle A. In this way, since the length of the support member 2 in the height direction of the vehicle A is smaller than the length of the side member 1 in the height direction of the vehicle A in the frame structure S, it is possible to realize lighter weight while ensuring the rigidity of the frame structure S.

### Modified Example

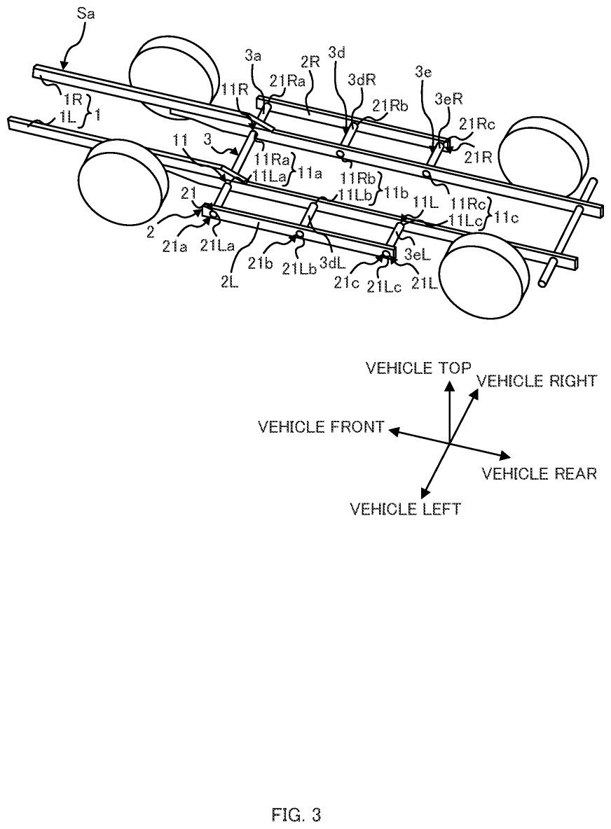

FIG. 3 shows a configuration of a frame structure Sa as a modified example.

Similar to the frame structure S, the frame structure Sa serving as the modified example includes the first cross member 3a that extends through the plurality of side members 1 in the width direction of the vehicle A. The frame structure Sa is different from the frame structure S in that it has a second cross member 3d and a third cross member 3e that do not extend through the plurality of side members 1 in the width direction of the vehicle A.

The frame structure Sa includes the plurality of side members 1, the plurality of support members 2, and at least one or more cross members 3. The frame structure Sa is provided with the first cross member 3a, the second cross member 3d, and the third cross member 3e as the at least one or more cross members 3.

Similar to the second cross member 3b, the second cross member 3d is provided at the centers of the plurality of support members 2 in the longitudinal direction of the vehicle A. The frame structure Sa is provided with a second left cross member 3dL and a second right cross member 3dR as the second cross members 3d. The second left cross member 3dL is provided between the left support member 2L and the left side member 1L. A left end of the second left cross member 3dL is fixed to the left support member 2L in a state of being inserted in the hole 21Lb of the left support member 2L. A right end of the second left cross member 3dL is fixed to the left side member 1L in a state of being inserted in the hole 11Lb of the left side member 1L.

The second right cross member 3dR is provided between the right support member 2R and the right side member 1R. A left end of the second right cross member 3dR is fixed to the right side member 1R in a state of being inserted in the hole 11Rb of the right side member 1R. A right end of the second right cross member 3dR is fixed to the right support member 2R in a state of being inserted in the hole 21Rb of the right support member 2R.

Similar to the third cross member 3c, the third cross member 3e is provided at rear ends of the plurality of support members 2 in the longitudinal direction of the vehicle A. In the frame structure Sa, a third left cross member 3eL and a third right cross member 3eR are provided as the third cross member 3e. The third left cross member 3eL is provided between the left support member 2L and the left side member 1L. A left end of the third left cross member 3eL is fixed to the left support member 2L in a state of being inserted in the hole 21Lc of the left support member 2L. A right end of the third left cross member 3eL is fixed to the left side member 1L in a state of being inserted in the hole 11Lc of the left side member 1L.

The third right cross member 3eR is provided between the right support member 2R and the right side member 1R. A left end of the third right cross member 3eR is fixed to the right side member 1R in a state of being inserted in the hole 11Rc of the right side member 1R. A right end of the third right cross member 3eR is fixed to the right support member 2R in a state of being inserted in the hole 21Rc of the right support member 2R.

The frame structure Sa is provided with the second cross member 3d and the third cross member 3e in this manner. In the frame structure Sa, the second cross member 3d and the third cross member 3e do not extend through the plurality of side members 1 in the width direction of the vehicle A. Therefore, the space between the plurality of side members 1 can be increased. As a result, in the frame structure Sa, it is possible to provide equipment of the vehicle A in the space between the plurality of the side members 1. The equipment of the vehicle A includes a battery, for example. The battery includes a battery used as a power supply battery for driving a motor for traveling of a hybrid vehicle or an Electric Vehicle (EV), for example.

### [Effects of the Frame Structure S According to the Present Embodiment]

The frame structure S according to the present embodiment includes the plurality of side members 1 which extend in the longitudinal direction of the vehicle A, and on which the cargo bed T of the vehicle A is to be mounted. Further, the frame structure S includes the plurality of support members 2, each of which is provided outward from the plurality of side members 1 in the width direction of the vehicle A and extends in the longitudinal direction of the vehicle A. Further, the frame structure S includes the at least one or more cross members 3 that are provided between the plurality of support members 2 and extend through the plurality of side members 1 in the width direction of the vehicle A.

In this way, the frame structure S includes the plurality of support members 2 and the at least one or more cross members 3 that are provided between the plurality of support members 2 and extend through the plurality of side members 1 in the width direction of the vehicle A. Therefore, in the frame structure S, the load applied to the plurality of side members 1 from the cargo bed T can be supported by the plurality of support members 2 as well, through the at least one or more cross members 3. As a result, the frame structure S can reduce the load supported by the plurality of side members 1, making it possible to reduce the lengths of the plurality of side members 1 in the height direction of the vehicle A. Therefore, the frame structure S makes it easier to provide the cargo bed T at a lower position.

The present disclosure is explained on the basis of the exemplary embodiments. The technical scope of the present disclosure is not limited to the scope explained in the above embodiments and it is possible to make various changes and modifications within the scope of the invention. all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

### DESCRIPTION OF REFERENCE NUMERALS

A vehicle
S, Sa frame structure
1, 1L, 1R side member
11, 11a, 11b, 11c, 11L, 11La, 11Lb, 11Lc, 11R, 11Ra, 11Rb, 11Rc hole
2, 2L, 2R support member
21, 21a, 21b, 21c, 21L, 21La, 21Lb, 21Lc, 21R, 21Ra, 21Rb, 21Rc hole
3, 3a, 3b, 3c, 3d, 3e, 3dL, 3dR, 3eL, 3eR cross member
T cargo bed

1. A frame structure comprising:
a plurality of side members which extend in a longitudinal direction of a vehicle and on which a cargo bed of the vehicle is to be mounted;
a plurality of support members, each of which is provided outward from the plurality of side members in a width direction of the vehicle and extends in the longitudinal direction; and
at least one or more cross members that are provided between the plurality of support members and extend through the plurality of side members in the width direction.

2. The frame structure according to claim 1, wherein
the frame structure is provided with, as the at least one or more cross members:
a first cross member provided at front ends of the plurality of support members in the longitudinal direction;
a second cross member provided at centers of the plurality of support members in the longitudinal direction; and
a third cross member provided at rear ends of the plurality of support members in the longitudinal direction.

3. The frame structure according to claim 1, wherein
a length of the support member in a height direction of the vehicle is smaller than a length of the side member in the height direction.

4. The frame structure according to claim 2, wherein
the first cross member extends through the plurality of side members in the width direction, and
the second cross member and the third cross member do not extend through the plurality of side members in the width direction.

5. The frame structure according to claim 4, wherein
the frame structure is provided with:
a left side member provided on a left side in the width direction, and
a right side member provided on a right side in the width direction, as the plurality of side members;
a left support member provided on a left side of the left side member in the width direction, and
a right support member provided on a right side of the right side member in the width direction, as the plurality of support members;
a second left cross member provided between the left support member and the left side member, and
a second right cross member provided between the right support member and the right side member, as the second cross members; and
a third left cross member provided between the left support member and the left side member, and
a third right cross member provided between the right support member and the right side member, as the third cross members.

6. The frame structure according to claim 5, wherein
upper ends of the second cross member and the third cross member are positioned below upper surfaces of the plurality of side members and upper surfaces of the plurality of support members.
